(19) United States
(12) Patent Application Publication
(10) Pub. No.: US 2026/0062567 A1
(43) Pub. Date: Mar. 5, 2026

(54) THERMAL INSULATION LAYER, METHOD OF MANUFACTURING THERMAL INSULATION LAYER, COATING LIQUID FOR FORMING THERMAL INSULATION LAYER, AND METHOD OF MANUFACTURING COATING LIQUID

(71) Applicant: DENSO CORPORATION, Kariya-city (JP)

(72) Inventors: Yasuhiro TAWARA, Kariya-city (JP); Shinichi OKAMOTO, Kariya-city (JP)

(21) Appl. No.: 19/313,952

(22) Filed: Aug. 29, 2025

(30) Foreign Application Priority Data
Sep. 5, 2024 (JP) 2024-152969

(51) Int. Cl. C09D 7/80; B01F 23/00; B01F 23/40; B01F 101/30; B05D 1/00; B05D 3/00; C09D 5/02; C09D 7/40; C09D 7/61; C09D 175/04

(52) U.S. Cl. CPC C09D 7/80; B01F 23/04; B01F 23/48; B05D 1/00; B05D 3/007; C09D 5/024; C09D 7/61; C09D 7/67; C09D 175/04; B01F 2101/30; B05D 2301/00; B05D 2401/21

(57) ABSTRACT

A thermal insulation layer of the present disclosure includes a binder resin. The binder resin contains a plurality of aggregates. The aggregate has a plurality of primary inorganic nanoparticles with hydrophobic functional groups on their surfaces and at least one pore formed by being surrounded by these primary inorganic nanoparticles. A coating liquid for forming the thermal insulation layer of the present disclosure includes the plurality of aggregates and a plurality of binder resin particles in solvent. The solvent contains water and alcohol. A ratio of the alcohol to the entire solvent is less than 46% by volume. In a method of manufacturing the thermal insulation layer of the present disclosure, the coating liquid is coated in a layered manner on a substrate, and then, the coated layer is dried to form the thermal insulation layer.

### CROSS-REFERENCE TO RELATED APPLICATION

This application is based on and claims the benefit of priority from earlier Japanese Patent Application No. 2024-152969, filed in Japan on Sep. 5, 2024, the description of which is hereby incorporated by reference.

### BACKGROUND

### 1. Technical Field

The present disclosure relates to a thermal insulation layer, a method of manufacturing thereof, a coating liquid for forming a thermal insulation layer, and a method of manufacturing thereof.

### 2. Related Art

A thermal insulation layer on a surface of a substrate, which is composed of metal materials, resins, rubber, or the like, is formed by coating with a coating liquid for forming this thermal insulation layer. In this method of forming the thermal insulation layer by coating, the thermal insulation layer is formed using a coating liquid to which a filler having a hollow structure or a porous aerogel is added. This reduces the thermal conductivity of the thermal insulation layer, ensuring effective thermal insulation properties.

### SUMMARY

The present disclosure primarily provides a thermal insulation layer and a method of manufacturing thereof.

A first aspect of the present disclosure provides a thermal insulation layer. This thermal insulation layer includes a binder resin. The binder resin contains a plurality of aggregates. The aggregate has a plurality of primary inorganic nanoparticles with hydrophobic functional groups on their surfaces and at least one pore formed by being surrounded by the plurality of primary inorganic nanoparticles.

A second aspect of the present disclosure provides a method of manufacturing a thermal insulation layer. This manufacturing method includes: a first process of coating a substrate with a coating liquid for forming the thermal insulation layer in a layered manner to form a coating layer; and a second process of drying the coating layer formed using the coating liquid to form the thermal insulation layer. In the first process, the coating layer is formed using the following coating liquid for forming the thermal insulation layer. The coating liquid for forming the thermal insulation layer includes a plurality of aggregates and a plurality of binder resin particles in solvent. The aggregate has a plurality of primary inorganic nanoparticles with hydrophobic functional groups on their surfaces and at least one pore formed by being surrounded by the plurality of primary inorganic nanoparticles. The solvent contains water and alcohol. A ratio of the alcohol to the entire solvent is less than 46% by volume.

### BRIEF DESCRIPTION OF THE DRAWINGS

In the accompanying drawings:

FIG. 1 shows a schematic cross-sectional view along a thickness direction of a configuration of a thermal insulation layer, according to an embodiment;

FIG. 2A shows a schematic cross-sectional view along a thickness direction of a configuration of a thermal insulation layer formed on a surface of a substrate, according to the embodiment;

FIG. 2B is a diagram for explaining a method of manufacturing a thermal insulation layer according to the embodiment.

FIG. 3 is a diagram for schematically illustrating a coating liquid for forming a thermal insulation layer (corresponding to a coating liquid for forming a thermal insulation layer of the embodiment) used in a method of manufacturing the thermal insulation layer, according to the embodiment.

FIG. 4 is a diagram for schematically illustrating a variation of a coating liquid for forming a thermal insulation layer shown in FIG. 3;

FIG. 5 is a diagram for explaining a method of manufacturing a coating liquid for forming a thermal insulation layer, according to the embodiment;

FIG. 6 is a diagram for illustrating a variation of a method of manufacturing a coating liquid for forming a thermal insulation layer shown in FIG. 5, according to the embodiment;

FIG. 7 is a scanning electron microscope (SEM) image of a cross-section along a in-plane direction of a thermal insulation layer formed by a coating liquid of Specimen 1, as obtained in experimental examples;

FIG. 8 is a graph showing pore size distributions of thermal insulation layers formed by coating liquids of Specimens 1 and 4, as obtained in the experimental examples;

FIG. 9 is optical images of surfaces of thermal insulation layers and transmission electron microscope (TEM) images of cross-sections along thickness directions of the thermal insulation layers formed by coating liquids of Specimens 1 and 8, as obtained in the experimental examples; and

FIG. 10 is a graph showing pore size distributions of thermal insulation layers formed by coating liquids of Specimens 1 and 8, as obtained in the experimental examples.

### DETAILED DESCRIPTION OF THE PREFERRED EMBODIMENTS

JP2018-123251A (Japanese Unexamined Patent Application Publication No. 2018-123251) describes the following coating material composition and a coating film with thermal insulation properties formed from this coating material composition. The coating material composition contains hollow particles composed of glass or the like, having a median diameter (particle size d50) within a range of 10 μm to 35 μm, and a ratio of the hollow particles in the non-volatile content within a range of 45% to 70% by volume.

Additionally, JP2019-501850A describes the following aerogel as a material with high thermal insulation properties. The aerogel is a highly porous material, having a porosity of approximately 90% to 99.9% and a pore size within a range of 1 nm to 100 nm. JP2022-055295A discloses technology relating to a composition for a thermal insulation material having a silica aerogel, an aqueous binder, and a thickener, as well as a thermal insulation material having a cured product of this composition for the thermal insulation material.

In the automotive field, for example, the electrification of vehicles is accelerating in order to achieve carbon neutrality. As a result, internal combustion engines, which used to be a source of heat, are no longer installed in vehicles. Therefore, from the viewpoint of heat management and similar considerations, higher insulation technology is required to control heat loss and enhance thermal efficiency.

However, in thermal insulation layers with hollow particles, there is a limit to how small a hollow structure can be made inside a particle. Therefore, it is difficult to further reduce the thermal conductivity.

Aerogel is a highly porous material. Therefore, a thermal insulation layer using the aerogel can reduce the thermal conductivity. However, aerogels have a complicated manufacturing process. Additionally, aerogels not only lose their thermal insulation properties due to moisture infiltrating their pores during use, but they also permanently lose these properties due to the pore structure being broken, which is caused by shrinkage during evaporation of infiltrated moisture. Thus, although the aerogel exhibits low initial thermal conductivity when in use, its thermal insulation properties decrease over time.

In view of the above, the present disclosure aims to provide a thermal insulation layer, a method of manufacturing thereof, a coating liquid for forming a thermal insulation layer, and a method of manufacturing thereof, which can achieve high thermal insulation properties and suppress decrease in thermal insulation properties during long-term use.

A thermal insulation layer according to a first aspect of the present disclosure includes a binder resin. The binder resin contains a plurality of aggregates. The aggregate has a plurality of primary inorganic nanoparticles with hydrophobic functional groups on their surfaces and at least one pore formed by being surrounded by the plurality of primary inorganic nanoparticles.

A method of manufacturing a thermal insulation layer according to a second aspect of the present disclosure includes:
a first process of coating a substrate with a coating liquid for forming the thermal insulation layer in a layered manner to form a coating layer; and
a second process of drying the coating layer formed using the coating liquid to form the thermal insulation layer.

In the first process, the coating layer is formed using the following coating liquid for forming the thermal insulation layer. The coating liquid for forming the thermal insulation layer includes a plurality of aggregates and a plurality of binder resin particles in solvent. The aggregate has a plurality of primary inorganic nanoparticles with hydrophobic functional groups on their surfaces and at least one pore formed by being surrounded by the plurality of primary inorganic nanoparticles. The solvent contains water and alcohol. A ratio of the alcohol to the entire solvent is less than 46% by volume.

A coating liquid for forming a thermal insulation layer according to a third aspect of the present disclosure includes a plurality of aggregates and a plurality of binder resin particles in solvent.

The aggregate has a plurality of primary inorganic nanoparticles with hydrophobic functional groups on their surfaces and at least one pore formed by being surrounded by the plurality of primary inorganic nanoparticles. The solvent contains water and alcohol. A ratio of the alcohol to the entire solvent is less than 46% by volume.

A method of manufacturing a coating liquid for forming a thermal insulation layer according to a fourth aspect of the present disclosure includes:
a first process of preparing a dispersion solution in which a plurality of primary inorganic nanoparticles with hydrophobic functional groups on their surfaces are dispersed in a dispersion medium;
a second process of producing a plurality of aggregates, including at least one pore formed by the plurality of primary inorganic nanoparticles, by mixing the prepared dispersion solution with an aggregation solution for agglomerating the dispersed primary inorganic nanoparticles; and
a third process of mixing an aqueous solution containing a plurality of binder resin particles with a mixed solution containing the plurality of aggregates.

The thermal insulation layer of the present disclosure contains numerous aggregates having pores (i.e, micropores) formed by being surrounded by numerous primary inorganic nanoparticles. According to the composition of the thermal insulation layer of the present disclosure, it is possible to lower the initial thermal conductivity, thereby achieving high thermal insulation properties. Additionally, in the thermal insulation layer, the primary inorganic nanoparticles that form the pores have hydrophobic functional groups on their surfaces. As a result, moisture infiltration into the pores during use is suppressed, thereby suppressing collapse of the pores due to moisture infiltration and shrinkage of the pores caused by evaporation of the infiltrated moisture. According to the composition of the thermal insulation layer of the present disclosure, it is possible to maintain a pore structure, thereby suppressing decrease in thermal insulation properties during long-term use.

In the method of manufacturing a thermal insulation layer of the present disclosure, the thermal insulation layer is formed by coating a coating liquid for forming the thermal insulation layer in a layered manner on a substrate and drying it. In this method, the coating liquid for forming the thermal insulation layer is used, which contains numerous aggregates and numerous binder resin particles in solvent. Here, each aggregate has numerous primary inorganic nanoparticles with hydrophobic functional groups on their surfaces and at least one pore formed by being surrounded by these primary inorganic nanoparticles. According to the method of manufacturing the thermal insulation layer of the present disclosure, forming the thermal insulation layer using the coating liquid described above enables the production of a thermal insulation layer that achieves high thermal insulation properties and suppresses decrease in thermal insulation properties during long-term use.

The coating liquid for forming a thermal insulation layer of the present disclosure contains numerous aggregates and numerous binder resin particles in solvent. Furthermore, each aggregate has numerous primary inorganic nanoparticles with hydrophobic functional groups on their surfaces and at least one pore formed by being surrounded by these primary inorganic nanoparticles. According to the composition of the coating liquid for forming the thermal insulation layer of the present disclosure, by performing a method of manufacturing a thermal insulation layer, in which this coating liquid is coated in a layered manner on a substrate and dried, it is possible to form a thermal insulation layer capable of achieving high thermal insulation properties and suppressing decrease in thermal insulation properties during long-term use.

The method of manufacturing a coating liquid for forming a thermal insulation layer of the present disclosure produces the coating liquid for forming the thermal insulation layer, which contains numerous aggregates and numerous binder resin particles in solvent. Here, each aggregate has numerous primary inorganic nanoparticles with hydrophobic functional groups on their surfaces and at least one pore formed by being surrounded by these primary inorganic nanoparticles. According to the method for manufacturing the coding liquid for forming the thermal insulation layer of the present disclosure, it is possible to produce a coating liquid for forming a thermal insulation layer capable of achieving high thermal insulation properties and suppressing decrease in thermal insulation properties during long-term use.

Each element may be marked with the bracketed reference signs in the various paragraphs in this description. In this case, the reference signs indicate one example of the correspondence between the same element and the specific configuration described in the embodiments below. Therefore, this disclosure is not limited by the reference signs.

### Embodiment

The following describes, using the drawings, a thermal insulation layer and a method of manufacturing thereof, as well as a coating liquid for forming a thermal insulation layer and a method of manufacturing thereof, of the present disclosure.

The following embodiments and variations thereof, as well as the related drawings, are schematic or simplified to briefly explain contents of the present disclosure. In each of the following embodiments, elements that are identical or equivalent to each other are marked with the same reference signs in the drawings. A thermal insulation layer and its manufacturing method, and a coating liquid for forming the thermal insulation layer and its manufacturing method of the present disclosure are not limited by examples of the embodiments described below. Additionally, each configuration of the thermal insulation layer and the coating liquid for forming the thermal insulation layer in the embodiments shown below may be arbitrarily combined as necessary. Each process of the method of manufacturing the thermal insulation layer and the coating liquid for forming the thermal insulation layer in the embodiments shown below may be arbitrarily combined as necessary. Each lower and upper limit of numerical value ranges in the embodiments shown below may be arbitrarily combined as necessary.

(Thermal insulation layer)

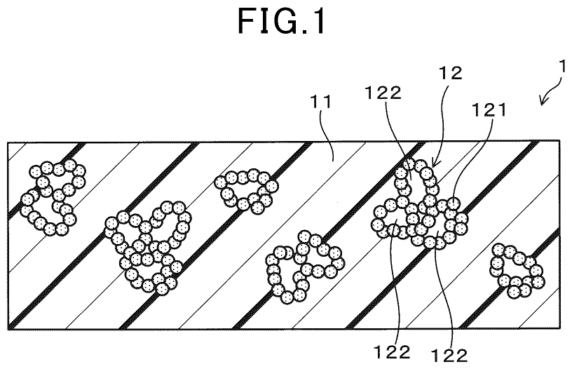

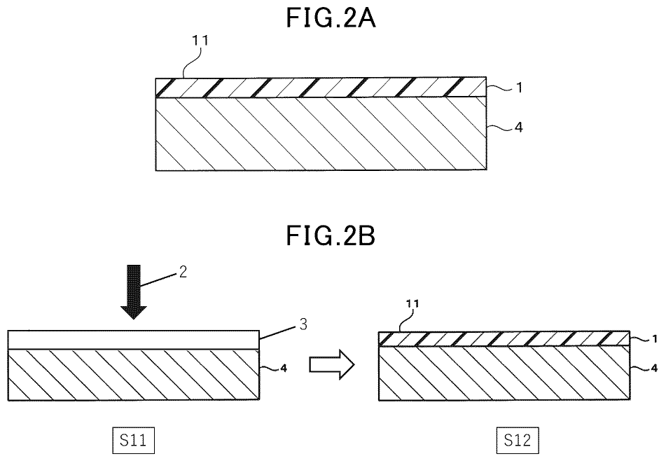

A thermal insulation layer of the present embodiment is explained using FIGS. 1 and 2.

The thermal insulation layer 1, for example, may be formed on a surface of a substrate 4, as illustrated in FIG. 2A. The thermal insulation layer 1 may be formed to cover an entire surface of the substrate 4, or may be formed to cover a part of the surface of the substrate 4. The substrate 4, for example, may be a base material that includes at least a part of a member or product requiring thermal insulation. Examples of materials for the substrate 4 include metallic materials (including alloys; hereinafter, the description is omitted), resin materials, rubber materials (including elastomer materials, hereinafter, the description is omitted), and similar materials. FIG. 2A illustrates the case where the substrate 4 has a flat surface. The surface of the substrate 4 may have an uneven shape, and is not limited to a flat surface.

The thermal insulation layer 1 contains a binder resin 11. The binder resin 11 contains a plurality of aggregates (i.e., massive materials; hereinafter, sometimes referred to as “numerous aggregates”) 12. FIG. 2A does not illustrate the aggregates 12. The binder resin 11 is a portion that functions as the matrix phase (base phase) of the thermal insulation layer 1. The binder resin 11 can be chosen based on the materials of the substrate 4 that forms the thermal insulation layer 1.

The binder resin 11 may preferably contain an anionic functional group because it shows favorable dispersibility in solvent 21, which contains water and alcohol. This solvent is part of a coating liquid 2, as described later, used to form the thermal insulation layer 1.

The binder resin 11 specifically includes at least one resin selected from a group containing an epoxy resin, a urethane resin, and a silicone resin. The epoxy resin has an OH group as the anionic functional group. The urethane resin has an OH group and a COOH group as the anionic functional groups. The silicone resin has an OH group as the anionic functional group. Thus, the epoxy resin, the urethane resin, and the silicone resin all have the anionic functional groups. In this case, the binder resin 11 can achieve the effects described above. In a case where the binder resin 11 includes the epoxy resin, it offers advantages such as achieving a thermal insulation layer 1 with both chemical resistance and high strength, in addition to high thermal insulation (high thermal insulation resistance). Similarly, in a case where the binder resin 11 includes the urethane resin, a thermal insulation layer 1 with high thermal resistance and abrasion resistance can be achieved. When the binder resin 11 includes the silicone resin, a thermal insulation layer 1 with high toughness and high thermal resistance can be achieved.

In the thermal insulation layer 1, each aggregate (massive material) 12 has a plurality of primary inorganic nanoparticles (hereinafter, sometimes referred to as “numerous primary inorganic nanoparticles”) 121 and at least one pore 122 formed by being surrounded by the plurality of primary inorganic nanoparticles 121. Here, the primary inorganic nanoparticles 121 refer to nanometer-sized primary particles of inorganic materials, which are the smallest unit of solid particles and cannot be further divided into smaller pieces. Therefore, the aggregate 12 is formed by the aggregation of the primary inorganic nanoparticles 121, i.e., it corresponds to a secondary particle. In the present disclosure, nanometer-size (nanometer-order) refers to a size within a range of greater than 0 nm and 1000 nm or less. Whether the primary inorganic nanoparticles 121 are nanometer-sized may be determined from a value of an average particle diameter (hereinafter, referred to as “average primary particle diameter”) of the primary inorganic nanoparticles 121. The value of the average primary particle diameter of the primary inorganic nanoparticles 121 is calculated as the arithmetic mean of the primary particle diameters of 200 arbitrarily selected primary inorganic nanoparticles 121 observed in a transmission electron microscope (TEM) image of a cross-section along a thickness direction of the thermal insulation layer 1.

Examples of the primary inorganic nanoparticles 121 may include ceramic particles and similar particles. One or more types of the primary inorganic nanoparticles 121 may be used in combination. In a case where the primary inorganic nanoparticles 121 are ceramic particles, it is easy to achieve low thermal conductivity in these nanoparticles 121 and achieve excellent thermal resistance. Therefore, in this case, it is advantageous to achieve the low thermal conductivity of the thermal insulation layer 1 and to improve durability.

Examples of the ceramic, which are a primary component of the ceramic particles, may include silica, glass, bentonite, and similar compounds; silica is preferred.

From the viewpoint of making it easier to handle and work with the particles, the average primary particle diameter of the primary inorganic nanoparticles 121 may preferably be 5 nm or more. Adjusting the average primary particle diameter of the primary inorganic nanoparticles 121 can make a pore size of the aggregate 12 smaller. From the viewpoint of making it easier to obtain the thermal insulation layer 1 with high thermal insulation properties, the average primary particle diameter of the primary inorganic nanoparticles 121 may preferably be 100 nm or less, more preferably 90 nm or less, and even more preferably 80 nm or less. The average primary particle diameter of the primary inorganic nanoparticles 121 may preferably be 70 nm or less, even more preferably 60 nm or less, and even more preferably 50 nm or less.

The primary inorganic nanoparticles 121 have hydrophobic functional groups on their surfaces. This causes the surfaces of the primary inorganic nanoparticles 121 to become hydrophobic. The primary inorganic nanoparticles 121 may have one or more types of the hydrophobic functional groups on their surfaces.

The hydrophobic functional group may preferably be at least one of an alkyl or alkoxy group. In this case, a degree of hydrophobicity can be easily adjusted by changing a carbon number in at least one of the alkyl or alkoxy group. From the viewpoint of ease of introduction and reaction efficiency, the hydrophobic functional group may preferably have the alkyl group.

Examples of the hydrophobic functional group may include an alkylsilyl group, an alkoxysilyl group, and similar groups. Examples of the alkylsilyl group may include a methyl silyl group and similar groups. The alkylsilyl group, for example, may also include any one of a trialkylsilyl group, a dialkylsilyl group, and a monoalkylsilyl group. In this embodiment, from the viewpoints such as a highly hydrophobic effect, the alkylsilyl group may preferably have a trimethylsilyl group.

Examples of the alkoxysilyl group may include a methoxysilyl group and similar groups. The alkoxysilyl group, for example, may also include any one of a trialkoxysilyl group, a dialkoxysilyl group, and a monoalkoxysilyl group. In this embodiment, from the viewpoints such as a highly hydrophobic effect, the alkoxysilyl group may preferably have a trimethoxysilyl group. One or more types of the hydrophobic functional groups may be used in combination.

In the aggregate 12, the pore 122 is formed by being surrounded by the plurality of primary inorganic nanoparticles 121 with the hydrophobic functional groups on their surfaces. In other words, the aggregate 12 is configured so that at least one pore 122 is maintained in an interior of the aggregate 12 by the plurality of primary inorganic nanoparticles 121 with the hydrophobic functional groups on their surfaces that adhere to each other. Accordingly, the plurality of primary inorganic nanoparticles 121 with the hydrophobic functional groups on their surfaces is arranged to surround the periphery of the pore 122. With this configuration, the infiltration of moisture into the pores 122 from the outside of the aggregate 12 is suppressed. One aggregate 12 needs only to have at least one pore 122 and may have multiple pores 122. The thermal insulation layer 11 may also include both the aggregates 12 that have at least one pore 122 and aggregates that do not have at least one pore 122. In the thermal insulation layer 1, the pores 122 are normally filled with the atmospheric air, but may be filled with gas other than the atmospheric air (e.g., a hydrocarbon gas or a noble gas). Additionally, as long as technical advantages provided by the thermal insulation layer 1 are not hindered, part of the solvent 21 in the coating liquid 2 for forming the thermal insulation layer 11 may remain in some of the pores 122 for manufacturing reasons.

The size of each pore 122 may preferably be nanometer-sized to achieve low thermal conductivity and the like.

From the viewpoint of achieving low thermal conductivity and the like, an average pore size (average pore diameter) of the pores 122 may preferably be 200 nm or less, more preferably 100 nm or less, and even more preferably 50 nm or less. The smaller the size of each pore 122 in the aggregates 12, the better from the viewpoint of thermal conductivity. Therefore, a lower limit value of the average pore size of the pores 122 is not particularly limited. However, from the viewpoint of manufacturing and the like, the average pore size of the pores 122 may preferably be 20 nm or more. The average pore size of the pores 122 can be measured by a mercury injection method.

The measurement conditions for the mercury injection method in the present embodiment are an initial pressure of 4 kPa, a mercury contact angle of 130°, and a mercury surface tension of 485 dynes/cm. The average pore size of the pores 122 mentioned above, specifically means a most frequent value (peak value) in a pore size distribution (also known as a bubble size distribution) of the thermal insulation layer 1.

From the viewpoint of ensuring effective thermal insulation properties, and the like, a thickness of the thermal insulation layer 1 may preferably be 300 μm or more, more preferably 500 μm or more, and even more preferably 700 μm or more. From the viewpoint of shortening drying time, improving productivity, and the like, the thickness of the thermal insulation layer 1 may preferably be 1500 μm or less, more preferably 1200 μm or less, and even more preferably 1000 μm or less. The thickness of the thermal insulation layer 1 refers to an average thickness and is calculated as the arithmetic mean of 10 measurements taken arbitrarily in a cross-section along the thickness direction of the thermal insulation layer 1.

The thermal insulation layer 1 of the present embodiment described above contains the numerous aggregates 12 having the pores (micropores) 122 formed by being surrounded by the numerous primary inorganic nanoparticles 121 in the binder resin 11, which makes it possible to lower the initial thermal conductivity, thereby achieving high insulation properties. The thermal insulation layer 1 of the present embodiment also has the hydrophobic functional groups on the surface of the primary inorganic nanoparticles 121 that form the pores 122. According to this configuration, moisture infiltration into the pores 122 during use is suppressed, thereby suppressing collapse of the pores 122 due to moisture infiltration and shrinkage of the pores 122 caused by evaporation of the infiltrated moisture. Therefore, the thermal insulation layer 1 of the present embodiment can maintain a pore structure, thereby suppressing decrease in thermal insulation properties during long-term use.

The description of “(Method of manufacturing a thermal insulation layer and a coating liquid for forming the thermal insulation layer)” and “(Method of manufacturing a coating liquid for forming a thermal insulation layer)” below may be referred to as necessary as the techniques of the present disclosure.

### (Method of Manufacturing a Thermal Insulation Layer and a Coating Liquid for Forming the Thermal Insulation Layer)

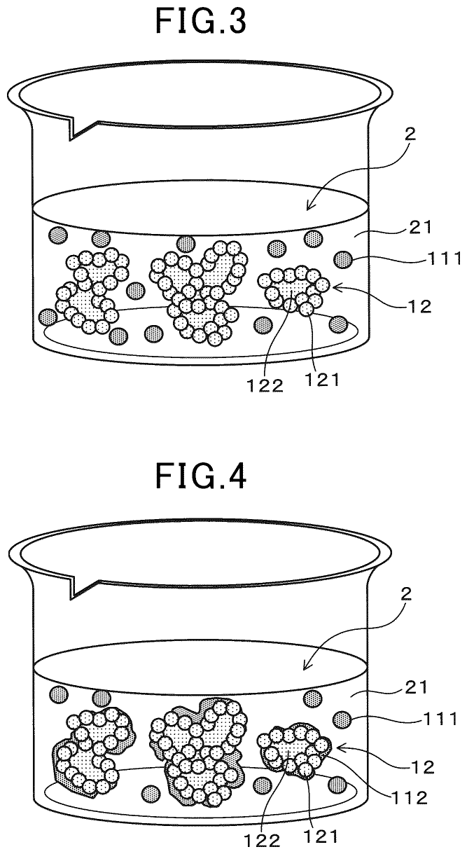

Next, a method of manufacturing the thermal insulation layer 1 of the present embodiment and the coating liquid 2 for forming the thermal insulation layer 1 of the present embodiment will be described using FIGS. 3 and 4. FIGS. 1 and 2A above will be referred to as appropriate in the following explanation.

In the method for manufacturing the thermal insulation layer 1 of the present embodiment, the coating liquid 2 for forming the thermal insulation layer 1 of the present embodiment is coated in a layered manner on the substrate 4, and then, the coated layer formed by the coating liquid 2 for forming the thermal insulation layer 1 is dried to form the thermal insulation layer 1.

Specifically, as illustrated in FIG. 2B, in the method of manufacturing the thermal insulation layer 1, the coating liquid 2 for forming the thermal insulation layer 2 is coated on the surface of the substrate 4 (refer to FIG. 2A) described above by various coating methods to form a coating layer 3 (first process of S11). Thereafter, in the method for manufacturing the thermal insulation layer 1, the coating layer 3, formed by the coating liquid 2 for forming the thermal insulation layer 1, is dried (second process S12). As a result, the thermal insulation layer 1 (refer to FIGS. 1 and 2A) of the present embodiment can be formed.

The coating method of the present embodiment, for example, may include spraying, brushing, molding by pouring into a mold, and coating by using a dispenser. The coating may be performed just once or may be performed multiple times under the same or different coating conditions.

From the viewpoint of shortening drying time, a drying temperature may preferably be 23° C. or higher, more preferably 40° C. or higher, and even more preferably 60° C. or higher. From the viewpoint of suppressing cracking during drying, the drying temperature may preferably be 80° C. or less, more preferably 70° C. or less, and even more preferably 60° C. or less. The drying may be performed just once or may be performed multiple times under the same or different drying conditions.

As illustrated in FIG. 3, the coating liquid 2 for forming the thermal insulation layer 1 in the present embodiment contains the plurality of aggregates 12 and the plurality of binder resin particles 111 in the solvent 21.

In the coating liquid 2 for forming the thermal insulation layer 1, the aggregate (massive material) 12 has the plurality of primary inorganic nanoparticles 121 with the hydrophobic functional groups on their surfaces and at least one pore 122 formed by being surrounded by the plurality of primary inorganic nanoparticles 121. The details of the aggregate 12 have been described above; therefore, its description is omitted. In the coating liquid 2 for forming the thermal insulation layer 1, the pore 122 may be partially filled with the solvent 21. Specifically, the pore 122 may be filled with alcohol and the like, which is part of the solvent 21, due to a method of manufacturing the coating liquid 2 for forming the thermal insulation layer 1, as described later. In FIG. 3, a region filled with dots shown within the pore 122 illustrates that the pore 122 is partially filled with the solvent 21.

In the coating liquid 2 for forming the thermal insulation layer 1, the binder resin particles 111 constitute the binder resin 11 in the thermal insulation layer 1 described above. The details of the binder resin 11 have been described above; therefore, its description is omitted. In the coating liquid 2 for forming the thermal insulation layer 1, one or more types of the binder resin particles 111 may be used in combination.

In the coating liquid 2 for forming the thermal insulation layer 1, the aggregate 12 is preferably covered with a resin layer 112 composed of the binder resin particles 111 on at least a part of an outer surface of the aggregate 12, as illustrated in FIG. 4. In this case, the shape of the aggregate 12 is protected by the resin layer 112 covering the outer surface of the aggregate 12, which is formed by the binder resin particles 111, and retention of the pore 122 is improved. Therefore, the coating liquid 2 for forming the thermal insulation layer 1 can increase the yield of manufacturing the insulation layer 1 having the effects described above.

In the coating liquid 2 for forming the thermal insulation layer 1 of the present embodiment, the solvent 21 contains water and alcohol. Therefore, the coating liquid 2 for forming the thermal insulation layer 1 corresponds to an aqueous coating solution.

A ratio of alcohol to the entire solvent 21 (hereinafter simply referred to as “ratio of alcohol in the solvent 21”) is less than 46% by volume.

When the ratio of alcohol in the solvent 21 is 46% by volume or more, it becomes difficult to produce the aggregate 12 with pores 122 formed by being surrounded by the plurality of primary inorganic nanoparticles 1. From the viewpoint such as reliably generating the aggregate 12 having pores 122, the ratio of alcohol in the solvent 21 may preferably be 44% by volume or less, more preferably 40% by volume or less, and even more preferably 38% by volume or less. The ratio of alcohol in solvent 21 may preferably be 35% by volume or less, and even more preferably 30% by volume or less.

In the coating liquid 2 for forming the thermal insulation layer 1 of the present embodiment, the alcohol constituting the solvent 21 may preferably be a lower alcohol with a carbon number of 5 or less. In this case, the average pore size of the pores 122 can be made smaller. Examples of lower alcohols with a carbon number of 5 or less may include methanol, ethanol, isopropyl alcohol (IPA), butanol, pentanol, and similar alcohols. One or more types of the lower alcohols with a carbon number of 5 or less may be used in combination.

Other materials may be added to the solvent 21 if the solvent 21, after adding, can form the thermal insulation layer 1. Examples of the other materials may include a metal salt and similar salts. The coating liquid 2 for forming the thermal insulation layer 1 is in a state where micro particles are dispersed, known as the emulsion state. In this case, the charge (e.g., negative charge) on surfaces of the binder resin particles 111 in the coating liquid 2 for forming the thermal insulation layer 1 is canceled by the metal salt. This disrupts the dispersion stability of some of the binder resin particles 111. In the coating liquid 2 for forming the thermal insulation layer 1, the binder resin particles 111 that have become unstable adhere to the outer surface of the aggregate 12. Therefore, when the metal salt is added to the solvent 21, it is easy to form a structure in which at least part of the outer surface of the aggregate 12 is covered by the resin layer 112 constituted by the binder resin particles 111. Thus, in this case, the retention of the pores 122 in the aggregate 12 is promoted.

Examples of the metal salt may include calcium chloride, calcium sulfate, sodium chloride, magnesium chloride, magnesium sulfate, and similar salts (ionic compounds). One or more types of the metal salts may be used in combination.

Examples of materials other than the metal salt may include pH adjusters, such as acids and alkaline materials.

The coating liquid 2 for forming the thermal insulation layer 1 of the present embodiment described above, for example, can be prepared by performing a method for manufacturing the coating liquid 2 for forming the thermal insulation layer 1 described below.

In the method of manufacturing the thermal insulation layer 1 of the present embodiment, the thermal insulation layer 1 is formed by coating the coating liquid 2 for forming the thermal insulation layer 1 in a layered manner on the substrate 4 and drying it. In this method, the coating liquid 2 for forming the thermal insulation layer 1 is used, which contains the numerous aggregates 12 and the numerous binder resin particles 111 in the solvent 21. Here, each aggregate 12 has the numerous primary inorganic nanoparticles 121 with the hydrophobic functional groups on their surfaces and at least one pore 122 formed by being surrounded by these primary inorganic nanoparticles 121. According to the method of manufacturing the thermal insulation layer 1 of the present embodiment, forming the thermal insulation layer 1 using the coating liquid 2 described above enables the production of the thermal insulation layer 1 that achieves high thermal insulation properties and suppresses decrease in thermal insulation properties during long-term use.

The coating liquid 2 for forming the thermal insulation layer 1 of the present embodiment contains the numerous aggregates 12 and the numerous binder resin particles 111 in the solvent 21. Furthermore, each aggregate 12 has numerous primary inorganic nanoparticles 121 with the hydrophobic functional groups on their surfaces and at least one pore 122 formed by being surrounded by these primary inorganic nanoparticles 121. According to the composition of the coating liquid 2 for forming the thermal insulation layer 1 of the present embodiment, by performing a method of manufacturing the thermal insulation layer 1, in which this coating liquid 2 is coated in a layered manner on the substrate 4 and dried, it is possible to form the thermal insulation layer 1 capable of achieving high thermal insulation properties and suppressing decrease in thermal insulation properties during long-term use.

The description of “(Thermal insulation layer)” above and the description of “(Method of manufacturing a coating liquid for forming a thermal insulation layer)” below may be referred to as necessary as the techniques of the present disclosure.

### (Method of Manufacturing a Coating Liquid for Forming a Thermal Insulation Layer)

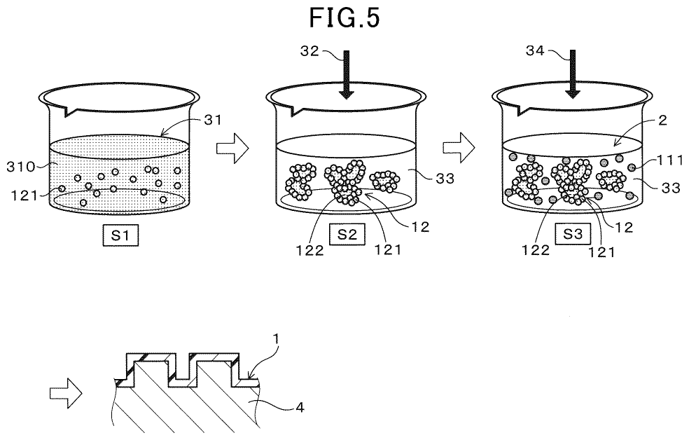

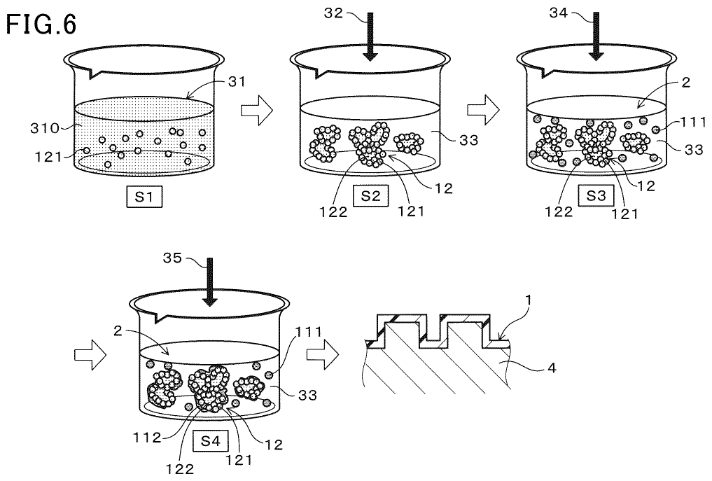

Next, a method of manufacturing the coating liquid 2 for forming the thermal insulation layer 1 of the present embodiment will be described using FIGS. 5 and 6.

The method of manufacturing the coating liquid 2 for forming the thermal insulation layer 1 of the present embodiment includes mainly three processes (a first process S1, a second process S2, and a third process S3).

The first process S1 is a process of preparing a dispersion solution 31 in which the plurality of primary inorganic nanoparticles 121 with the hydrophobic functional groups on their surfaces are dispersed in a dispersion medium 310, as illustrated in FIG. 5.

The primary inorganic nanoparticles 121 with the hydrophobic functional groups on their surfaces can be prepared by performing a surface treatment to have the hydrophobic functional groups on the surfaces of the primary inorganic nanoparticles 121. The detailed configuration of the primary inorganic nanoparticles 121 with the hydrophobic functional groups on their surfaces has been described above in the description of “(Thermal insulation layer)”; therefore, its description is omitted.

As the dispersion medium 310, alcohol or the like can be suitably used from the viewpoint of monodispersing the primary inorganic nanoparticles 121 and the like. The alcohol may preferably be a lower alcohol with a carbon number of 5 or less. In this case, the average pore size of the pores 122 in the aggregate 12 formed can be made smaller. Examples of lower alcohols with a carbon number of 5 or less may include methanol, ethanol, isopropyl alcohol (IPA), butanol, and pentanol, and similar alcohols. One or more types of the lower alcohols with a carbon number of 5 or less may be used in combination.

The second process S2 is a process of mixing the dispersion solution 31 with an aggregation solution 32, which agglomerates the dispersed primary inorganic nanoparticles 121, to produce the plurality of aggregates 12, including at least one pore 122 formed by the plurality of primary inorganic nanoparticles 121, as illustrated in FIG. 5.

As the aggregation solution 32, water or the like can be suitably used from the viewpoint of securely agglomerating the dispersed primary inorganic nanoparticles 121 and the like. When alcohol is used as the dispersion medium 310 and water as the aggregation solution 32, the solvent 21 of the resulting coating liquid 2 for forming the thermal insulation layer 1 is constituted to contain both water and alcohol. By mixing the dispersion solution 31 with the aggregation solution 32, the ratio of alcohol to the entire solvent 12 in the resulting coating liquid 2 for forming the thermal insulation layer 1 can be adjusted so that the ratio of alcohol to the entire solvent 21 is less than 46% by volume.

In the second process S2, as illustrated in FIG. 5, the primary inorganic nanoparticles 121 that have been monodispersed in the dispersion solution 31 are agglomerated by mixing with the aggregation solution 32. As a result, the plurality of aggregates 12, having the pores 122 formed by being surrounded by the plurality of primary inorganic nanoparticles 121, are generated. In this case, the aggregates 12 agglomerate in the dispersion solution 31. Therefore, the formed pores 122 are filled with the dispersion medium 310. In FIG. 5, a region filled with dots shown within the pore 122 illustrates that the pore 122 is filled with the dispersion medium 310.

The third process S3 is a process of mixing an aqueous solution (hereinafter, for convenience, referred to as “aqueous resin solution”) 34 containing the binder resin particles 111 with the mixed solution 33 containing the plurality of aggregates 12, as illustrated in FIG. 5.

The binder resin particles 111 contained in the aqueous resin solution 34 constitute the binder resin 11 in the thermal insulation layer 1 formed by the resulting coating liquid 2 for forming the thermal insulation layer 1. The details of the binder resin 11 constituted by the binder resin particles 111 have been described above in the description of “(Thermal insulation layer)”; therefore, its description is omitted.

The coating liquid 2 for forming the thermal insulation layer 1, produced by performing the first process S1 to the third process S3, is coated on the surface of the substrate 4 using various coating methods, as illustrated in FIG. 2B. As a result, the coating layer 3 is formed. The formed coating layer 3 is then dried to form the thermal insulation layer 1 as illustrated in FIG. 5.

This method of manufacturing the coating liquid 2 for forming the thermal insulation layer 1, for example, may further include a fourth process S4, as illustrated in FIG. 6.

The fourth process S4 is a process of mixing the metal salt 35 with the mixed solution 33 in which the aqueous resin solution 34 is mixed. When the method of manufacturing the coating liquid 2 for forming the thermal insulation layer 1 includes the fourth process S4, the metal salt 35 enables the binder resin particles 111 dispersed in the mixed solution 33 to adhere to the outer surface of the aggregate 12. The charge (e.g., negative charge) on the surfaces of the binder resin particles 111 in the mixed solution 33 with the aqueous resin solution 34 in the emulsion state is canceled by the metal salt 35. This disrupts the dispersion stability of some of the binder resin particles 111. In the mixed solution 33, the binder resin particles 111 that have become unstable adhere to the outer surface of the aggregate 12. Therefore, when the method of manufacturing the coating liquid 2 for forming the thermal insulation layer includes the fourth process S4, it is easy to form a structure in which at least part of the outer surface of the aggregate 12 is covered by the resin layer 112 constituted by the binder resin particles 111. With this manufacturing method, the retention of the pores 122 in the aggregate 12 is promoted.

Examples of the metal salt 35 may include calcium chloride, calcium sulfate, sodium chloride, magnesium chloride, magnesium sulfate, and similar compounds.

One or more types of the metal salts 35 may be used in combination. The metal salt 35, for example, may be mixed with the mixed solution 33 as an aqueous solution containing a metal salt.

The coating liquid 2 for forming the thermal insulation layer 1, produced by performing the first process S1 to the fourth process S4, is coated on the surface of the substrate 4 using various coating methods, as illustrated in FIG. 2B. As a result, the coating layer 3 is formed. The formed coating layer 3 is then dried to form the thermal insulation layer 1 as illustrated in FIG. 6. Note that, in FIGS. 5 and 6 above, the illustrations corresponding to the aggregates 12 in the thermal insulation layer 1 are omitted.

As described above, the method of manufacturing the coating liquid 2 for forming the thermal insulation layer 1 of the present embodiment produces the coating liquid 2 for forming the thermal insulation layer 1, which contains the numerous aggregates 12 and the numerous binder resin particles 111 in the solvent 21. Here, each aggregate 12 has the numerous primary inorganic nanoparticles 121 with the hydrophobic functional groups on their surfaces and at least one pore 122 formed by being surrounded by these primary inorganic nanoparticles 121. According to the method for manufacturing the coding liquid 2 for forming the thermal insulation layer 1 of the present embodiment, it is possible to produce the coating liquid 2 for forming the thermal insulation layer 1 capable of achieving high thermal insulation properties and suppressing decrease in thermal insulation properties during long-term use.

### Experimental Examples

### <Preparation of Specimen 1>

Specimen 1 was prepared as follows. First, ethanol was added to nano-silica (“AEROSIL” (registered trademark) manufactured by AEROSIL Japan, Inc.) with an average primary particle diameter of 40 nm, whose surface has been treated with trimethylsilyl groups, and the ethanol after adding was stirred using an agitator until the nano-silica was dispersed evenly. Thereby, a dispersion solution was prepared in which numerous primary inorganic nanoparticles (primary nano-silica particles) with the trimethylsilyl groups on their surfaces were dispersed in ethanol.

Then, deionized water (ion-exchanged water) was dripped into the dispersion solution (i.e., aqueous solution containing ethanol), in which the primary inorganic nanoparticles were uniformly dispersed, during a period of more than 5 minutes, to achieve an ethanol concentration (ratio of alcohol in solvent) of 24% by volume. The solution was then stirred for 5 minutes as an aggregation solution. Therefore, a first mixture solution was prepared, composed of a mixed slurry of water and ethanol, which contained numerous aggregates obtained by agglomerating the dispersed primary inorganic nanoparticles.

Next, the deionized water was added to urethane resin emulsion (“PERMARIN UA-368” manufactured by Sanyo Chemical Industries, Ltd.), to achieve a solid content of 20 parts by mass. The solution was then stirred. Thereby, an aqueous resin solution containing binder resin particles was prepared. Then, this aqueous resin solution was dropped into the above first mixture solution during a period of more than 5 minutes to achieve a content of 25 parts by mass of a binder resin for 100 parts by mass of the primary inorganic nanoparticles. The solution was then stirred for 5 minutes. Therefore, the resin aqueous solution containing the binder resin particles was mixed with the mixed solution containing numerous aggregates, thereby preparing a second mixture solution.

Next, the deionized water was added to calcium chloride as a metal salt and stirred. Therefore, an aqueous solution containing calcium chloride (hereinafter, for convenience, referred to as “aqueous calcium chloride solution”) with a concentration of 10% by mass was prepared. Then, this aqueous calcium chloride solution was dropped into the above second mixture solution during a period of more than 5 minutes to achieve a content was 1.2 parts by mass of the calcium chloride for 100 parts by mass of the primary inorganic nanoparticles. The solution was then stirred for 5 minutes. Therefore, the calcium chloride, as the metal salt, was mixed with the above second mixture solution.

A coating liquid for forming a thermal insulation layer of Specimen 1 was prepared as described above.

Next, the prepared coating liquid was poured into a mold, and the mold was placed in an oven with a hot air circulation structure at 80° C. for 1 hour to dry. The temperature was then increased to 100° C., and the mold was dried for an additional hour. A film-shaped thermal insulation layer with a thickness of 200 μm of Specimen 1 was thus obtained.

### <Preparation of Specimens 2 to 4>

The difference in the preparation conditions between Specimens 2 to 4 and Specimen 1 is that an average primary particle diameter of primary inorganic nanoparticles was changed, as shown in Table 1. Specimens 2 to 4 were prepared under the same conditions as Specimen 1, except for the aforementioned points; thereby, each coating liquid and thermal insulation layer of Specimens 2 to 4 was obtained.

### <Preparation of Specimen 5>

The difference in the preparation conditions between Specimen 5 and Specimen 1 is that nano-silica with a dimethylsilyl group-treated surface (“AEROSIL” (registered trademark) manufactured by AEROSIL Japan, Inc.) was used instead of nano-silica with a trimethylsilyl group-treated surface. Specimen 5 was prepared under the same conditions as Specimen 1, except for the aforementioned points; thereby, a coating liquid and a thermal insulation layer for Specimen 5 were obtained.

### <Preparation of Specimen 6>

The difference in the preparation conditions between Specimen 6 and Specimen 1 is that an aqueous isopropyl alcohol (IPA) solution was used instead of an aqueous ethanol solution. Specimen 6 was prepared under the same conditions as Specimen 1, except for the aforementioned points; thereby, a coating liquid and a thermal insulation layer for Specimen 6 were obtained.

### <Preparation of Specimen 7>

The difference in the preparation conditions between Specimen 7 and Specimen 1 is that an octanol solution was used instead of an ethanol solution. Specimen 7 was prepared under the same conditions as Specimen 1, except for the aforementioned points; thereby, a coating solution and a thermal insulation layer for Specimen 7 were obtained.

### <Preparation of Specimen 8>

The difference in the preparation conditions between Specimen 8 and Specimen 1 is that an aqueous solution containing calcium chloride (metal salt) was not added to a second mixed solution, in which an aqueous resin solution was mixed. Specimen 8 was prepared under the same conditions as Specimen 1, except for the aforementioned points; thereby, a coating liquid and a thermal insulation layer for Specimen 8 were obtained.

### <Preparation of Specimen 1C>

Specimen 1C was prepared by referring to Example 5 described in JP 2022-055295A (Japanese Unexamined Patent Application Publication No. 2022-055295). Specifically, a composition for thermal insulation with a silica aerogel was prepared, which was used as a coating liquid for Specimen 1C. A thermal insulation layer for Specimen 1C was formed by using the coating liquid of Specimen 1C.

### <Preparation of Specimen 2C>

The difference in the preparation conditions between Specimen 2C and Specimen 1 is that nano-silica, whose surface is not treated with hydrophobic functional groups (“AEROSIL” (registered trademark) manufactured by AEROSIL Japan, Inc.), was used instead of nano-silica whose surface is treated with trimethylsilyl groups. Specimen 2C was prepared under the same conditions as Specimen 1, except for the aforementioned points; thereby, a coating liquid and a thermal insulation layer for Specimen 2C were obtained.

### <Preparation of Specimen 3C>

The difference in the preparation conditions between Specimen 3C and Specimen 1 is that ion-exchanged water as an aggregation solution was dripped into an ethanol solution (dispersion solution) in which primary inorganic nanoparticles were uniformly dispersed, during a period of more than 5 minutes, to achieve an ethanol concentration of 46% by volume, and the solution was then stirred for 5 minutes. Specimen 3C was prepared under the same conditions as Specimen 1, except for the aforementioned points; thereby, a coating solution and a thermal insulation layer for Specimen 3C were obtained.

### <Various Evaluations>

### —Pore Formation—

Using a transmission electron microscope (TEM), a cross-sectional image was captured along a thickness direction of a thermal insulation layer of Specimen, and a cross-section was observed in the captured image. This confirmed the presence or absence (Yes/No) of an aggregate (massive material) having micropores formed by being surrounded by numerous primary inorganic nanoparticles. If the presence of the aggregate having the micropores is confirmed in the thermal insulation layer, it can be inferred that the aggregate contained in the coating liquid used to form the thermal insulation layer also has pores.

A section was cut from a thermal insulation layer of Specimen and used as a sample for measuring the pore size. A pore size distribution of the sample for the measurement was measured by a mercury injection method using a pore size distribution measuring device (“Autopore V9620”, manufactured by Micromeritics Instrument Corporation). The measurement conditions for the mercury injection method were as follows: an initial pressure of 4 kPa, a mercury contact angle of 130°, and a mercury surface tension of 485 dynes/cm. A most frequent value (peak value) in the pore size distribution (bubble size distribution) of the thermal insulation layer was defined as an average pore size of the pores contained in the aggregate of the thermal insulation layer.

If pores were confirmed in the aggregate, an evaluation result of “A” was assigned when the average pore size was 200 nm or less, and the evaluation result of “B” was assigned when the average pore size exceeded 200 nm.

### —Thermal Insulation Properties—

The thermal conductivity of a thermal insulation layer of Specimen was measured using an “HFM436”, manufactured by NETZSCH Corporation. The measurement conditions were room temperature (23° C.±3° C.).

An evaluation result of “A” was assigned, indicating excellent thermal insulation properties, when the thermal conductivity of the thermal insulation layer was 0.03 W/m·K or less. The evaluation result of “B” was assigned, indicating mid-level thermal insulation properties, when the thermal conductivity of the thermal insulation layer was within a range of greater than 0.03 W/m·K and 0.1 W/m·K or less. The evaluation result of “C” was assigned, indicating poor thermal insulation properties, when the thermal conductivity of the insulation layer was greater than 0.1 W/m·K.

### —Durability—

A thermal insulation layer of Specimen was placed in a constant temperature and humidity chamber and exposed to an 85° C. and 85% RH environment for 1000 hours. The thermal insulation layer was then dried in an oven with a hot air circulation structure at 100° C. for 6 hours. This resulted in a thermal insulation layer being obtained after the durability treatment. The thermal conductivity of the thermal insulation layer after the durability treatment was measured in the same way as in the evaluation method of the thermal insulation properties.

The thermal conductivity of the thermal insulation layer before and after the durability treatment was compared, and when the increase in the thermal conductivity was less than 20%, an evaluation result of “A” was assigned, indicating that the decrease in the thermal insulation properties during long-term use was suppressed. When the increase in the thermal conductivity was 20% or more, the evaluation result of “C” was assigned, indicating that the decrease in the thermal insulation properties during long-term use was not suppressed. The increase in the thermal conductivity was calculated using the formula: 100×(|(thermal conductivity of thermal insulation layer after durability treatment−thermal conductivity of thermal insulation layer before durability treatment)|/(thermal conductivity of thermal insulation layer before durability treatment)). The “| |” in the formula represents an absolute value.

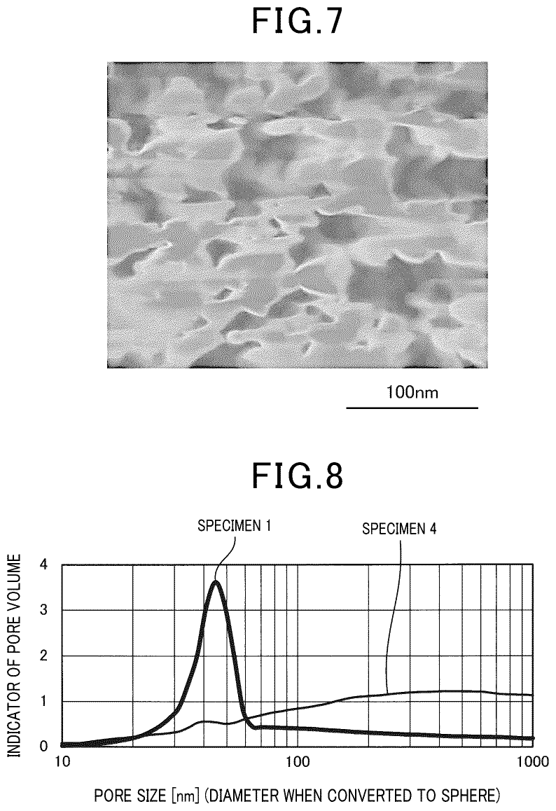

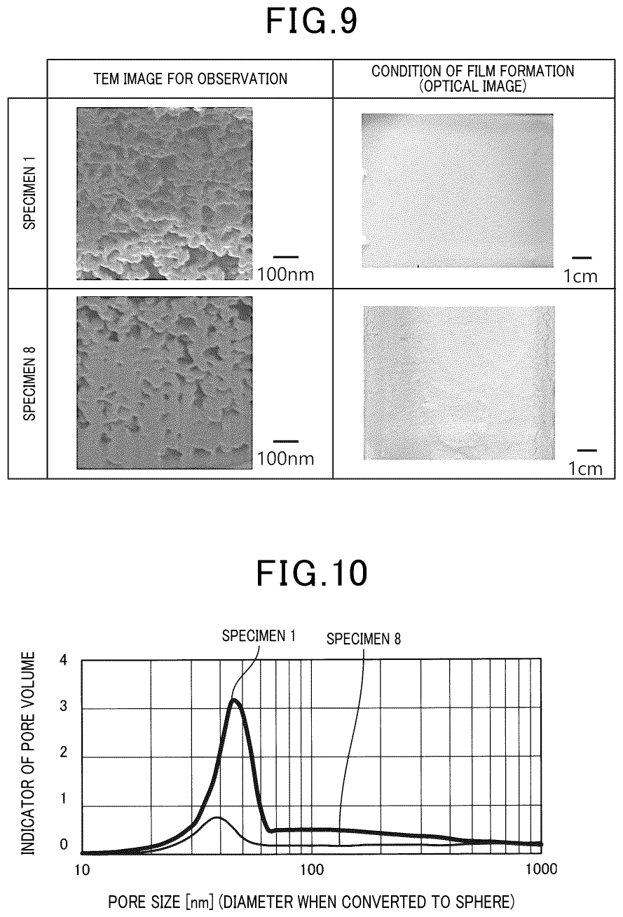

Table 1 presents the detailed composition of a coating liquid and various evaluation results, for each Specimen. Additionally, FIGS. 7 to 10 show the examples of a SEM image, optical images, TEM images, pore size distributions, and the like, of a thermal insulation layer formed by the coating liquid, for each Specimen. FIG. 7 is a SEM image of a cross-section along a in-plane direction of a thermal insulation layer formed by a coating liquid of Specimen 1. FIG. 8 is a graph showing pore size distributions of thermal insulation layers formed by coating liquids of Specimens 1 and 4. FIG. 9 is optical images of surfaces of thermal insulation layers and TEM images of cross-sections along thickness directions of the thermal insulation layers formed by coating liquids of Specimens 1 and 8. FIG. 10 is a graph showing pore size distributions of thermal insulation layers formed by coating liquids of Specimens 1 and 8.

TABLE 1

| | | | Spec- | Spec- | Spec- | Spec- | Spec- | Spec- |
|---|---|---|---|---|---|---|---|---|
| | | | imen• | imen• | imen• | imen• | imen• | imen• |
| ¤ | | | 1¤ | 2¤ | 3¤ | 4¤ | 5¤ | 6¤ |
| Liquid• | Primary• | | ¤ | ¤ | ¤ | ¤ | ¤ | ¤ |
| composition¤ | inorganic• | | | | | | | |
| | nanoparticles¤ | | | | | | | |
| | ¤ | Average• | 40 nm¤ | 25 nm¤ | 100 nm¤ | 1 μm¤ | 40 nm¤ | 40 nm¤ |
| | | primary• | | | | | | |
| | | particle• | | | | | | |
| | | diameter¤ | | | | | | |
| | ¤ | Hydrophobic• | Trimethyl- | Trimethyl- | Trimethyl- | Trimethyl- | Dimethyl- | Trimethyl- |
| | | functional• | silyl• | silyl• | silyl• | silyl• | silyl• | silyl• |
| | | groups• | group¤ | group¤ | group¤ | group¤ | group¤ | group¤ |
| | | on•particle• | | | | | | |
| | | surface¤ | | | | | | |
| | Solvent• | | ¤ | ¤ | ¤ | ¤ | ¤ | ¤ |
| | (containing• | | | | | | | |
| | water•and• | | | | | | | |
| | alcohol)¤ | | | | | | | |
| | ¤ | Alcohol• | Ethanol¤ | Ethanol¤ | Ethanol¤ | Ethanol¤ | Ethanol¤ | Isopropyl• |
| | | type¤ | | | | | | alcohol¤ |
| | ¤ | Ratio•of• | 24¤ | 24¤ | 24¤ | 24¤ | 24¤ | 24¤ |
| | | alcohol• | | | | | | |
| | | to•entire• | | | | | | |
| | | solvent• | | | | | | |
| | | (%•by• | | | | | | |
| | | volume)¤ | | | | | | |
| | Metal•salt¤ | | ¤ | ¤ | ¤ | ¤ | ¤ | ¤ |
| | ¤ | Content• | 1.2¤ | 1.2¤ | 1.2¤ | 1.2¤ | 1.2¤ | 1.2¤ |
| | | (parts•by• | | | | | | |
| | | mass)¤ | | | | | | |
| | Binder• | | ¤ | ¤ | ¤ | ¤ | ¤ | ¤ |
| | resin• | | | | | | | |
| | particles¤ | | | | | | | |
| | ¤ | Content• | 25¤ | 25¤ | 25¤ | 25¤ | 25¤ | 25¤ |
| | | (parts•by• | | | | | | |
| | | mass)¤ | | | | | | |
| Evaluation• | Pore• | | ¤ | ¤ | ¤ | ¤ | ¤ | ¤ |
| Results¤ | formation¤ | | | | | | | |
| | ¤ | Presence• | Presence• | Presence¶ | Presence¶ | Presence¶ | Presence¶ | Presence¶ |
| | | or•absence• | (Yes)¤ | (Yes)¤ | (Yes)¤ | (Yes)¤ | (Yes)¤ | (Yes)¤ |
| | | of•aggregates• | | | | | | |
| | | (containing• | | | | | | |
| | | primary• | | | | | | |
| | | inorganic• | | | | | | |
| | | nanoparticles• | | | | | | |
| | | and•pores)¤ | | | | | | |
| | ¤ | Pore•size¤ | A¤ | A¤ | A¤ | B¤ | A¤ | A¤ |
| | Thermal• | | ¤ | ¤ | ¤ | ¤ | ¤ | ¤ |
| | insulation• | | | | | | | |
| | properties¤ | | | | | | | |
| | ¤ | Thermal• | 0.025¶ | 0.025¶ | 0.026¶ | 0.06¶ | 0.025¶ | 0.025¶ |
| | | conductivity• | A¤ | A¤ | A¤ | B¤ | A¤ | A¤ |
| | | (W/m · K)¤ | | | | | | |

| | | | | | | |
|---|---|---|---|---|---|---|
| Durability¤ | A¤ | A¤ | A¤ | A¤ | A¤ | A¤ |

| | | Spec- | Spec- | Spec- | Spec- | Spec- | |
|---|---|---|---|---|---|---|---|
| | | imen• | imen• | imen• | imen• | imen• | |
| ¤ | | 7¤ | 8¤ | 1C¤ | 2C¤ | 3C¤ | ¤ |
| Liquid• | Primary• | ¤ | ¤ | Silica• | ¤ | ¤ | ¤ |
| composition¤ | inorganic• | | | aerogel¤ | | | |
| | nanoparticles¤ | | | | | | |

| ¤ | Average• | 40 nm¤ | 40 nm¤ | 40 nm¤ | 40 nm¤ | ¤ |
|---|---|---|---|---|---|---|
| | primary• | | | | | |
| | particle• | | | | | |
| | diameter¤ | | | | | |
| ¤ | Hydrophobic• | Trimethyl- | Trimethyl- | —¤ | Trimethyl- | ¤ |
| | functional• | silyl• | silyl• | | silyl• | |
| | groups• | group¤ | group¤ | | group¤ | |
| | on•particle• | | | | | |
| | surface¤ | | | | | |
| Solvent• | | ¤ | ¤ | ¤ | ¤ | ¤ |
| (containing• | | | | | | |
| water•and• | | | | | | |
| alcohol)¤ | | | | | | |
| ¤ | Alcohol• | Octanol¤ | Ethanol¤ | Ethanol¤ | Ethanol¤ | ¤ |
| | type¤ | | | | | |
| ¤ | Ratio•of• | 23¤ | 24¤ | 24¤ | 46¤ | ¤ |
| | alcohol• | | | | | |
| | to•entire• | | | | | |
| | solvent• | | | | | |
| | (%•by• | | | | | |
| | volume)¤ | | | | | |
| Metal•salt¤ | | ¤ | ¤ | ¤ | ¤ | ¤ |
| ¤ | Content• | 1.2¤ | 0¤ | 1.2¤ | 1.2¤ | ¤ |
| | (parts•by• | | | | | |
| | mass)¤ | | | | | |
| Binder• | | ¤ | ¤ | ¤ | ¤ | ¤ |
| resin• | | | | | | |
| particles¤ | | | | | | |
| ¤ | Content• | 25¤ | 25¤ | 25¤ | 25¤ | ¤ |
| | (parts•by• | | | | | |
| | mass)¤ | | | | | |

| | | | | | | | |
|---|---|---|---|---|---|---|---|
| Evaluation• | Pore• | ¤ | ¤ | ¤ | ¤ | ¤ | ¤ |
| Results¤ | formation¤ | | | | | | |

| ¤ | Presence• | Presence¶ | Presence¶ | —¤ | Presence¶ | Absence¶ | ¤ |
|---|---|---|---|---|---|---|---|
| | or•absence• | (Yes)¤ | (Yes)¤ | | (Yes)¤ | (No)¤ | |
| | of•aggregates• | | | | | | |
| | (containing• | | | | | | |
| | primary• | | | | | | |
| | inorganic• | | | | | | |
| | nanoparticles• | | | | | | |
| | and•pores)¤ | | | | | | |
| ¤ | Pore•size¤ | B¤ | A¤ | A¤ | A¤ | —¤ | ¤ |
| Thermal• | | ¤ | ¤ | ¤ | ¤ | ¤ | ¤ |
| insulation• | | | | | | | |
| properties¤ | | | | | | | |
| ¤ | Thermal• | 0.06¶ | 0.06¶ | 0.025¶ | 0.06¶ | 0.2¶ | ¤ |
| | conductivity• | B¤ | B¤ | A¤ | B¤ | C¤ | |
| | (W/m · K)¤ | | | | | | |

| | | | | | | |
|---|---|---|---|---|---|---|
| Durability¤ | A¤ | A¤ | C¤ | C¤ | A¤ | ¤ |

As shown in Table 1 and FIGS. 7 to 10, the following can be observed. The thermal insulation layer of Specimen 1C is a thermal insulation layer formed using a coating liquid containing a silica aerogel. The silica aerogel is a highly porous material. Therefore, the thermal insulation layer of Specimen 1C, formed using this coating liquid, has a low thermal conductivity. However, the thermal insulation layer of Specimen 1C exhibits low thermal insulation during long-term use (evaluation result of durability: C). This is because a pore structure of the silica aerogel was broken due to collapse of the pores caused by moisture infiltration and shrinkage of the pores caused by evaporation of moisture that infiltrated the pores.

In Specimen 2C, primary inorganic nanoparticles used in a coating liquid do not have hydrophobic functional groups on their surface. The thermal insulation layer of Specimen 2C, formed using this coating liquid, exhibits low thermal insulation properties during long-term use (evaluation result of durability: C). This is because a pore structure could not be maintained due to collapse of the pores caused by moisture infiltration and shrinkage of the pores caused by evaporation of moisture that infiltrated the pores.

In Specimen 3C, a ratio of alcohol to the entire solvent in a coating liquid is 46% by volume or more. The thermal insulation layer of Specimen 3C formed using this coating liquid exhibits a high thermal conductivity and low thermal insulation properties (evaluation result of thermal insulation properties: C). This is because an aggregate (massive material) having pores formed by numerous primary inorganic nanoparticles in the coating liquid could not be formed due to the ratio of alcohol to the entire solvent in the coating liquid being 46% by volume or more.

In contrast, in Specimens 1 to 8, coating liquids that meet the conditions specified in the present disclosure were prepared and used to form thermal insulation layers. According to the thermal insulation layers of Specimens 1 to 8, it has been confirmed that high thermal insulation properties can be achieved and that decrease in thermal insulation properties during long-term use can be suppressed (evaluation results of thermal insulation properties: A or B, evaluation results of durability: A).

Comparing Specimens 1 to 8, a pore size in an aggregate (massive material) can be made smaller when an average primary particle diameter of primary inorganic nanoparticles is 100 nm or less. As a result, it is easier to obtain a thermal insulation layer with high thermal insulation properties. Similarly, when a lower alcohol with a carbon number of 5 or less is used as the alcohol in a coating liquid, the pore size in the aggregate can be made smaller. As a result, it is easier to obtain a thermal insulation layer with high thermal insulation properties.

The techniques of the present disclosure is not limited to the above embodiments and the above experimental examples. Various modifications can be made to the techniques of the present disclosure to the extent that it does not depart from the gist thereof. The elements explained in the above embodiments and the above experimental examples can be combined with each other as long as there is no technical contradiction therebetween.

The following supplementary notes are provided regarding the techniques disclosed herein.

### SUPPLEMENTARY NOTES

### Supplementary Note 1

There is provided a thermal insulation layer including a binder resin containing a plurality of aggregates, in which
the aggregate has a plurality of primary inorganic nanoparticles with hydrophobic functional groups on their surfaces and at least one pore formed by being surrounded by the plurality of primary inorganic nanoparticles.

### Supplementary Note 2

The thermal insulation layer according to Supplementary note 1, in which the primary inorganic nanoparticle is a ceramic particle.

### Supplementary Note 3

The thermal insulation layer according to supplementary note 1 or 2, in which the average primary particle diameter of the primary inorganic nanoparticles is within a range of 5 nm or more and 100 nm or less.

### Supplementary Note 4

The thermal insulation layer according to any one of supplementary notes 1 to 3, in which a size of the pore is nanometer-sized.

### Supplementary Note 5

The thermal insulation layer according to any one of supplementary notes 1 to 4, in which the hydrophobic functional group has at least one of an alkyl group or an alkoxy group.

### Supplementary Note 6

The thermal insulation layer according to any one of supplementary notes 1 to 5, in which the binder resin includes at least one resin selected from a group containing an epoxy resin, a urethane resin, and a silicone resin.

### Supplementary Note 7

There is provided a method of manufacturing a thermal insulation layer, including:
a first process of coating a substrate with a coating liquid for forming the thermal insulation layer in a layered manner to form a coating layer; and
a second process of drying the coating layer formed using the coating liquid to form the thermal insulation layer, in which
in the first process, the coating layer is formed using the following coating liquid for forming the thermal insulation layer, in which
the coating liquid for forming the thermal insulation layer includes a plurality of aggregates and a plurality of binder resin particles in solvent,
the aggregate has a plurality of primary inorganic nanoparticles with hydrophobic functional groups on their surfaces and at least one pore formed by being surrounded by the plurality of primary inorganic nanoparticles,
the solvent contains water and alcohol, and
a ratio of the alcohol to the entire solvent is less than 46% by volume.

### Supplementary Note 8

There is provided a coating liquid for forming a thermal insulation layer, including a plurality of aggregates and a plurality of binder resin particles in solvent, in which
the aggregate has a plurality of primary inorganic nanoparticles with hydrophobic functional groups on their surfaces and at least one pore formed by being surrounded by the plurality of primary inorganic nanoparticles,
the solvent contains water and alcohol, and
a ratio of the alcohol to the entire solvent is less than 46% by volume.

### Supplementary Note 9

The coating liquid according to supplementary note 8, in which at least a part of an outer surface of the aggregate is covered by a resin layer composed of the binder resin particles.

### Supplementary Note 10

The coating liquid according to supplementary note 8 or 9, in which the alcohol is a lower alcohol with a carbon number of 5 or less.

### Supplementary Note 11

There is provided a method of manufacturing a coating liquid for forming a thermal insulation layer, including:
a first process of preparing a dispersion solution in which a plurality of primary inorganic nanoparticles with hydrophobic functional groups on their surfaces are dispersed in a dispersion medium;
a second process of producing a plurality of aggregates, including at least one pore formed by the plurality of primary inorganic nanoparticles, by mixing the prepared dispersion solution with an aggregation solution for agglomerating the dispersed primary inorganic nanoparticles; and
a third process of mixing an aqueous solution containing a plurality of binder resin particles with a mixed solution containing the plurality of aggregates.

### Supplementary Note 12

The method of manufacturing the coating liquid for forming the thermal insulation layer according to supplementary note 11, further including a fourth process of mixing a metal salt in the mixed solution, in which the aqueous resin solution is mixed.

What is claimed is:

1. A thermal insulation layer, comprising a binder resin containing a plurality of aggregates, wherein
the aggregate has a plurality of primary inorganic nanoparticles with hydrophobic functional groups on their surfaces and at least one pore formed by being surrounded by the plurality of primary inorganic nanoparticles.

2. The thermal insulation layer according to claim 1, wherein
the primary inorganic nanoparticle is a ceramic particle.

3. The thermal insulation layer according to claim 1, wherein
the average primary particle diameter of the primary inorganic nanoparticles is within a range of 5 nm or more and 100 nm or less.

4. The thermal insulation layer according to claim 1, wherein
a size of the pore is nanometer-sized.

5. The thermal insulation layer according to claim 1, wherein
the hydrophobic functional group has at least one of an alkyl group or an alkoxy group.

6. The thermal insulation layer according to claim 1, wherein
the binder resin includes at least one resin selected from a group containing an epoxy resin, a urethane resin, and a silicone resin.

7. A method of manufacturing a thermal insulation layer, comprising:
a first process of coating a substrate with a coating liquid for forming the thermal insulation layer in a layered manner to form a coating layer; and
a second process of drying the coating layer formed using the coating liquid to form the thermal insulation layer, wherein
in the first process, the coating layer is formed using the following coating liquid for forming the thermal insulation layer, wherein
the coating liquid for forming the thermal insulation layer includes a plurality of aggregates and a plurality of binder resin particles in solvent,
the aggregate has a plurality of primary inorganic nanoparticles with hydrophobic functional groups on their surfaces and at least one pore formed by being surrounded by the plurality of primary inorganic nanoparticles,
the solvent contains water and alcohol, and
a ratio of the alcohol to the entire solvent is less than 46% by volume.

8. A coating liquid for forming a thermal insulation layer, comprising
a plurality of aggregates and a plurality of binder resin particles in solvent, wherein
the aggregate has a plurality of primary inorganic nanoparticles with hydrophobic functional groups on their surfaces and at least one pore formed by being surrounded by the plurality of primary inorganic nanoparticles,
the solvent contains water and alcohol, and
a ratio of the alcohol to the entire solvent is less than 46% by volume.

9. The coating liquid according to claim 8, wherein
at least a part of an outer surface of the aggregate is covered by a resin layer composed of the binder resin particles.

10. The coating liquid according to claim 8, wherein
the alcohol is a lower alcohol with a carbon number of 5 or less.

11. A method of manufacturing a coating liquid for forming a thermal insulation layer, comprising:
a first process of preparing a dispersion solution in which a plurality of primary inorganic nanoparticles with hydrophobic functional groups on their surfaces are dispersed in a dispersion medium;
a second process of producing a plurality of aggregates, including at least one pore formed by the plurality of primary inorganic nanoparticles, by mixing the prepared dispersion solution with an aggregation solution for agglomerating the dispersed primary inorganic nanoparticles; and
a third process of mixing an aqueous solution containing a plurality of binder resin particles with a mixed solution containing the plurality of aggregates.

12. The method of manufacturing the coating liquid for forming the thermal insulation layer according to claim 11, further comprising
a fourth process of mixing a metal salt in the mixed solution, in which the aqueous resin solution is mixed.
